(19) United States
(12) Patent Application Publication
(10) Pub. No.: US 2025/0122685 A1
(43) Pub. Date: Apr. 17, 2025

(54) FOUNDATION FOR AN OFFSHORE WIND TURBINE

(71) Applicant: EQUINOR ENERGY AS, Stavanger (NO)

(72) Inventor: Arne Kristian DAHL, Fornebu (NO)

(21) Appl. No.: 18/550,360

(22) PCT Filed: Mar. 25, 2022
(86) PCT No.: PCT/NO2022/050074

§ 371 Date: Sep. 13, 2023

(30) Foreign Application Priority Data
Mar. 29, 2021 (GB) 2104439.1

(51) Int. Cl. E02B 17/02; E02B 17/00; E02D 27/42; E02D 27/52; F03D 9/25; F03D 13/25

(52) U.S. Cl. CPC E02B 17/025; E02D 27/425; E02D 27/525; F03D 9/25; F03D 13/25; E02B 2017/0065; E02B 2017/0091; E02D 2300/002; F05B 2220/706; F05B 2240/95

(57) ABSTRACT

A transition piece for use in a foundation of an offshore wind turbine including a tubular concrete support structure for supporting the wind turbine. The concrete support structure has a first end arranged to receive an end portion of a pile for mounting the transition piece on the pile and a second end distal from the first end for supporting the wind turbine. The transition piece may form part of the foundation for the offshore wind turbine in which the transition piece is mounted on the end of the pile extending from the sea floor. The end of the pile on which the transition piece is mounted is below the surface of the water and the transition piece protrudes above the surface of the water such that the wind turbine may be mounted thereon.

The present invention relates to a foundation for an offshore wind turbine as well as to methods of manufacturing and installing a foundation for an offshore wind turbine.

It has become common to use pile foundations for constructing fixed-foundation offshore wind turbines in shallow-water locations. A pile is an elongate, typically cylindrically shaped, structure that is driven into the sea floor to provide a stable foundation for the offshore wind turbine. Once installed, the pile extends above the surface of the water and provides a platform on top of which the wind turbine structure can be mounted.

Piles that are used for wind turbine foundations are typically formed of steel, for instance in the form of long, hollow steel structures. This use of steel can lead to manufacturing and transportation issues when offshore wind turbines are to be installed at locations where the supply of steel is relatively scarce. More commonly, given the massive size of a typical steel pile, it can often be difficult, or even impossible, to manufacture piles locally to the installation site if there are not the necessary specialist manufacturing facilities and/or skilled workforce available.

To overcome these issues, it has been common to manufacture steel piles at a central manufacturing plant before transporting, e.g. shipping, the piles to installation sites. However, this can be often be difficult and/or uneconomical. Transporting the piles, often over long distances, e.g. between a manufacturing plant in Europe and installation sites in the USA, can be heavily impacted by weather. For instance, the large volume and mass of the piles means that they can only be transported in certain weather conditions, and delays can arise as a result of having to wait for a window of suitable weather to allow transportation. Transporting the piles over such large distances can also be inefficient and result in additional greenhouse gas emissions from the transportation vessels.

In a first aspect, the present invention may provide a transition piece for use in a foundation of an offshore wind turbine, the transition piece comprising: a tubular concrete support structure for supporting a wind turbine, the concrete support structure having a first end arranged to receive an end portion of a pile for mounting the transition piece on the pile, and a second end distal from the first end for supporting a wind turbine.

“Tubular” or “tube” is used herein to refer to an elongate, hollow structure of any suitable cross-section. Hence, the concrete support structure may be an elongate, hollow, cylindrical concrete structure.

The transition piece allows foundations for offshore wind turbines to be provided which use shorter piles compared to those used conventionally in fixed-foundation offshore wind turbines, whilst still allowing offshore wind turbines to be installed at the same or similar depths. Whereas one end of a conventional pile extends into the sea floor and the other end protrudes above the waterline, this is no longer necessary when the transition piece of the first aspect is used. Instead, a pile may be used that only extends a short way out of the sea floor, for instance to a distance of 8-10 m above the sea floor. The transition piece may be used to extend the foundation from the pile and/or sea floor to above the waterline, using the pile as a supporting foundation. The transition piece therefore preferably has a length that is sufficient to extend from the sea floor to above the waterline.

Depending on the depth of the sea at the installation site, the concrete support structure may have a length of up to 50 m. Given the need for the pile to extend above the seabed, it will be appreciated that, whilst the transition piece may be used in any depth of water, its advantages become apparent at lengths of 10 or 15 metres, or longer, and are most significant at greater depths. Thus, preferably, the concrete support structure has a length of at least 20 m, more preferably at least 30 m.

The first end of the concrete support may be arranged to engage peripherally with the end of the pile, i.e. the first end may be open and arranged to be fitted over and around the end of a pile. In other words, the first end of the concrete support may be arranged so that it may form a sleeve around the end of a pile. To this end, the tubular concrete support structure may have an inside diameter sufficient to receive an end portion of a pile. The inside diameter of the concrete support structure may be dimensioned such that the end of a pile may fit closely within the concrete support structure, and may be only 100 mm to 300 mm larger than the outside diameter of a conventional pile. For instance, the inside diameter of the concrete support structure may be in the range of 5 m to 15 m, preferably in the range of 9 m to 11 m.

It is not always possible to install a pile in a perfectly vertical orientation. Accordingly, a certain amount of annular space may be provided between the outside diameter of the pile and the internal diameter of the concrete support structure to allow for adjustment of the latter to correct for small deviations of the pile from the vertical.

As discussed further below, grout may be used to fill the gap between the pile and the concrete support.

The wall of the concrete support structure may have a thickness within the range of 100 mm to 200 mm. For instance, the thickness of the wall may be 140 mm to 160 mm, optionally 145 mm to 155 mm. The wall of the concrete support structure may have a constant thickness along its length.

The concrete support structure may have a diameter similar to that of a conventional pile. Hence, the concrete support structure may have an outside diameter in the range of 5 m to 15 m, for instance 9 m to 11 m.

The concrete support structure is preferably formed of reinforced concrete, i.e. incorporating a reinforcing material embedded within the concrete. The reinforcing material may include steel rebars or the like. A reinforced concrete support structure may be able to withstand greater forces, e.g. shear forces or bending moments, before failing compared to a non-reinforced structure. Hence, a reinforced concrete support structure may be suitable for use in harsher sea conditions compared to a non-reinforced support structure.

The concrete support structure may be formed of prestressed concrete. This may improve the tensile strength of the concrete support structure compared to a non-prestressed concrete structure.

The transition piece may include a skirt coupled to the first end of the concrete support structure for inserting into the sea floor. The skirt may comprise a tubular section, preferably of constant diameter.

When the transition piece is being installed on a pile projecting from the sea floor, the skirt may be allowed to sink into, or be driven into, the sea floor. This may provide additional support for the transition piece by enabling axial loads and torsional forces to be transferred to the sea floor. The skirt may also be used to protect against scouring during installation. The skirt may help to guide the transition piece onto an end of a pile during installation of the transition piece onto the pile.

The skirt may be formed of steel. In order to resist buckling, e.g. when the skirt sinks into, or is driven into, the sea floor, the skirt may be corrugated. For instance, the skirt may be formed of corrugated steel plate. The corrugations of the skirt are preferably oriented parallel to the length of the transition piece.

The length of the skirt may differ depending on the type of soil present on the sea floor at the installation site. For instance, the skirt may be longer when the transition piece is to be installed at a location where the soil is soft compared to when the soil is hard. It will be appreciated that the softer the soil the greater the depth into the sea floor the skirt may be required to penetrate in order to provide a predetermined level of support for the transition piece. For example, for installation in soft soil, the skirt may penetrate 2 m or more into the sea floor whereas for hard soil it may be adequate for the skirt to penetrate less than 2 m into the sea floor. Hence, the skirt may have a length within the range of 1 m to 5 m.

The inside diameter of the skirt is preferably sufficient for the end of a pile to be received within and/or passed through the skirt. Hence, the inside diameter of the skirt is preferably equal to or larger than the inside diameter of the concrete support structure. For example, the inside diameter of the skirt may be in the range 5 m to 15 m.

The skirt may comprise connection rods extending longitudinally outward from an end of the skirt for engaging the skirt with the concrete support structure. The connection rods may extend into and/or be embedded within the concrete wall of the concrete support structure at the first end. For instance, the concrete support structure may be cast or otherwise formed around the connection rods of the skirt so that the connection rods become embedded within the wall of the concrete support structure.

A plurality of connection rods, for instance up to 10, up to 20 or up to 30 connection rods, may be spaced around the end of the skirt. The connection rods may be made from the same material as the skirt. For instance, the connection rods may be formed of steel.

The concrete support structure preferably comprises a single, monolithic structure. This may be achieved by using a slip-forming technique to manufacture the concrete support structure. It will be appreciated that, when the concrete support structure comprises a single structure, it will not include any joints between different concrete sections. The structure may be weakened by the presence of joints between separate concrete sections; hence the absence of such joints may make a monolithic concrete support structure stronger than a concrete support structure formed from several pieces that have been joined together. A monolithic concrete support structure may therefore be able to withstand rougher sea conditions compared to a support structure formed of multiple pieces.

Nevertheless, in some applications it may be more practicable for the concrete support structure to comprise multiple, i.e. more than one, pieces of concrete that have been joined together, for example with grout, to form the support structure. The individual pieces may be in the form of tubular rings that may be joined together at their ends to form the support structure. In another example, the support structure may be formed from plural curved wall sections, e.g. two that each define a semicircle in cross-section, i.e. a half-pipe. These half-pipe sections may be joined along the length of the concrete support structure.

The concrete support structure may be coated in epoxy. The epoxy coating may be applied to the outer and/or inner surface(s) of the wall of the concrete support structure, or portions thereof. An epoxy coating may be of particular benefit when the concrete support structure is formed of multiple pieces that have been joined together. The epoxy may help to waterproof the wall, for instance by sealing the joints, against ingress and/or egress of fluid, such as sea water. The epoxy may be provided only at and/or adjacent to the joints, where present, so as to make the joints watertight.

The first (lower) end transition piece may include a lip, for example in the form of a flange, projecting radially outward from the concrete support structure. The lip may have an outer diameter that is 5 m to 10 m larger than the outer diameter of the support structure. Preferably, the lip extends outwardly from the first end of the support structure. In this way, the lip can be used to increase the diameter of the transition piece where it will contact the sea floor (i.e. at the first end) during and after installation of the transition piece on a pile. This may act to support the transition piece. For instance, when the lip rests on the sea floor the transition piece may be more stable against overturning. This may assist during installation of the transition piece on the pile and may also lead to a more stable foundation structure after installation. The lip may be formed of concrete, preferably reinforced concrete, and may be formed integral with the concrete support structure. The lip may otherwise be a separate piece that is coupled to the concrete support structure.

One or more projections may extend radially inward from the inner surface of the concrete support structure. The projections may preferably be arranged to abut (e.g. rest on) the upper end of a pile extending from the sea floor, during and/or after installation of the transition piece on the pile. In this way, the projections may be used to control how far the transition piece overlaps with the end of the pile. This can be particularly beneficial when the transition piece is installed in regions where the sea floor is weak or soft since the projections can rest on the end of the pile and prevent the transition piece from sinking into the sea floor beyond a predetermined depth. The projections may include a single projection that extends around the inner circumference of the concrete support structure, or may include multiple projections spaced apart around the inner circumference. The projections may be positioned up to 10 m from the first end of the concrete support structure.

The one or more projections may be formed integral with the concrete support structure, or may be separate piece(s) mounted to the inner wall of the concrete support structure. For instance, the projections may comprise one or more L-shaped brackets (e.g. steel brackets) affixed to the inner wall of the concrete support structure.

The one or more projections may be adjustably mounted to the inner surface of the concrete support structure such that the distance between the projections and the first end of the concrete support structure can be adjusted. For instance, the position of the projections may be hydraulically adjustable. This allows for control over the amount of overlap between the transition piece and the pile. The distance by which the transition piece extends into the sea floor, and the extent by which the transition piece extends above the surface of the water, can also be controlled by adjusting the position of the projections.

Each of the projections may be independently adjustable. This may allow the transition piece to be placed at an angle relative to the pile on which it is mounted. For instance, the projections may be adjusted to orient the transition piece closer towards the vertical compared to the pile.

An inflatable packer may be positioned on an underside of each of the projections such that the inflatable packers rest on the end of the pile during and/or after installation of the transition piece on the pile. The extent of overlap between the transition piece and the pile and/or the orientation of the transition piece relative to the pile may be adjusted by controlling the extent by which the packers are inflated (e.g. by inflating and/or deflating the packers). Hence, the inflatable packers provide a function similar to the adjustable projections described above.

The transition portion may include one or more conduits for directing liquid, such as grout, towards the first end. The conduit(s) may extend along the length of the concrete support structure, e.g. from the second end towards the first end. The conduit(s) may be in the form of piping that runs through the centre of the concrete support structure, for example being attached to an inner side of the wall of the concrete support structure. Alternatively, the conduit(s) may be formed within the wall of the concrete support structure. For example, the conduit(s) may comprise voids within the wall of the concrete support structure. In this case, an end of each conduit may form an opening at the inner surface of the wall of the concrete support structure at the first end such that fluid may be directed radially inwards at the first end of the concrete support structure. The conduit(s) may have a diameter within the range 50 mm to 80 mm.

The conduit(s) may allow fluid, such as grout, to be passed from the second end of the concrete support structure which, during installation, may be above the surface of the water, to an internal surface of the concrete support structure at the first end. Thus, the conduit(s) may allow grout to be poured at the first end of the transition piece, so that a grout connection may be formed between the pile and the transition piece in a convenient manner.

A plurality of conduits, for example three, four, five or more conduits may be spaced about the perimeter of the concrete support structure. This may help provide a more even flow of grout to first end during installation of the transition piece.

The transition piece may comprise at least one ballast tank for storing ballast. The ballast tank(s) can be used to adjust the buoyancy of the transition piece by allowing ballast, e.g. sea water, to be added or removed from the transition piece. This may be of use to assist in manipulating the transition piece when lowering and installing the transition piece onto a pile protruding from the sea floor.

It will be appreciated that the tubular concrete structure encompasses a volume. This volume may be separated into watertight and/or airtight compartments. This may be useful it if is desired to float the transition piece to its installation site thereby avoiding the need for it to be carried by a vessel. The concrete support structure may comprise dividers arranged to seal off sections of the volume of the concrete support structure in order to form the compartments. For example, two dividers may be provided within the internal volume and spaced apart along the length of the concrete support structure in order to enclose a volume, i.e. a compartment, between the dividers and the wall of the concrete support structure. The dividers may provide a watertight and/or airtight seal between compartment(s). The concrete support structure may include one, two, three or more of such compartments. The compartment(s) may be utilised as ballast tanks for holding ballast within the transition piece. As noted above, the compartments may be selectively flooded (or drained) to change the orientation and total buoyancy of the concrete support structure when manipulating it during installation.

The transition piece may include a ladder at the second end of the concrete support structure for enabling access from sea level to the second end of the concrete support structure once it has been installed on a pile. This may enable workers, such as maintenance personnel, to gain access to the transition piece, and any wind turbine supported thereon, from a vessel alongside the transition piece by scaling the ladder. The ladder may be attached to the outer surface of the concrete support structure. The ladder may extend longitudinally along a length of the concrete support structure. Preferably, the ladder extends downwardly from the second end a distance suitable to reach the water line when the transition piece is installed.

The transition piece may comprise one or more decks within the interior of the concrete support structure. The decks may be provided towards the second end of the concrete support structure. This may provide workspace for maintenance personnel and/or storage space. Decks may be spaced apart along the longitudinal direction of the transition piece to provide a series of floors within the transition piece. Access to the floors may be provided by stairs or ladders extending between the floors.

The transition piece may comprise an external platform mounted at the second end. The external platform may be mounted to the second end of the concrete support structure. A portion of the external platform may be fitted over and around the second end of the concrete support structure so as to receive the second end of the concrete support structure. An annular gap may be provided between the outer surface of the concrete support structure and a surface of the external platform. The external platform may be attached to the transition piece by a grouted connection, for instance by providing grout in the annular gap. The ladder may extend to the external platform to provide access to the external platform.

The outside diameter of the concrete support structure may vary along its length, i.e. the outside diameter of the concrete support structure may not be constant. The concrete support structure may, for example, comprise a portion of constant outside diameter extending from the first end, with a portion that tapers (i.e. a frustoconical portion) towards the second end. The tapered portion may have a length of less than 10 m. Due to the tapered portion, the second end of the concrete support structure may have a smaller outside diameter compared to the first end and/or the portion of constant diameter. The outside diameter of the second end may be up to 3 m less than the diameter at the first end. The tapered end of the transition piece may provide improved support for an external platform or other structure provided around it by preventing these structures from sliding down the transition piece after installation and during operation. The tapered portion may also help to mitigate grout failure in a grout connection provided between the second end of the concrete support and a wind turbine, for example.

The concrete support structure may have a seal at the first end for sealing against an outside surface of a pile. The seal may extend around the inner surface of the concrete support structure. When securing the transition piece to a pile, grout may be poured in the annular gap between the outer surface of the pile and the inner surface of the support structure. The seal may prevent grout from leaking out of the annular gap and into the surrounding sea water. The seal may be an inflatable seal. In this way, the annular gap can be sealed after the transition portion has been lowered onto a pile by inflating the seal. Alternatively, the seal may comprise a rubber lip extending radially inwards from the inner surface of the concrete support structure.

The present invention may extend to a foundation for an offshore wind turbine comprising the transition piece of the first aspect. Hence, in a second aspect, the invention may provide a foundation for an offshore wind turbine comprising: a pile having a toe end embedded in the sea floor and a distal end extending upwardly from the sea floor, wherein the distal end of the pile is below the surface of the water; and the transition piece of the first aspect mounted on the distal end of the pile, wherein the transition piece protrudes above the surface of the water.

The foundation for an offshore wind turbine of the second aspect may include any one or more or all of the optional features discussed above in respect of the first aspect.

Unlike pile foundations that are conventionally used as foundations for offshore wind turbines, the pile used in the foundation of the second aspect does not extend from the sea floor to above the waterline, i.e. it is submerged. Rather, the pile may extend only a relatively small distance up from the sea floor. For instance, the pile may extend not more than 10 m away from the sea floor. The section of the foundation that extends from the distal end of the pile to above the waterline is provided by the transition piece.

The pile is used to provide the main structural support for the foundation. It may in some cases extend up to 50 m into the sea floor, but optionally and more commonly up to 40 m into the sea floor. However, since it is not required to extend to above the waterline, the pile may be substantially shorter than those conventionally used for supporting a fixed-foundation offshore wind turbine. For example, the pile may have a length of not more than 60 m, preferably not more than 50 m.

As discussed above, it has been known to transport steel piles for wind turbine installation over large distances from specialist manufacturing plants to the installation sites. The pile used in the foundation of the second aspect is much shorter than conventional piles, so it may have less mass and be easier and/or more economical to transport. For instance, due to its shorter length and lower mass, it may be possible to transport a greater number of the piles on a single vessel compared to conventional piles. This may mean fewer journeys are needed to transport piles between the manufacturing site and the installation site of an offshore wind farm, for example. Moreover, the journeys that are made when transporting the pile(s) may produce lower amounts of greenhouse gasses, such as CO₂. This is because it may be more energy efficient to transport the lighter, shorter piles. Moreover, it may be possible to transport the piles during more extreme weather conditions. This may result in fewer or shorter delays as a result of having to wait for acceptable weather conditions to transport the piles to the installation site.

Concrete is easier to work with since it is a commonly used building material and the skills required to manufacture structures out of concrete are much more widely known. In addition, specialist foundries or the like are not required. Instead, the transition piece can be constructed at an outdoor site using apparatus common to a conventional construction site. Accordingly, using the foundation of the second aspect means that fewer components need to be transported over large distances, which may lead to reduced transportation times, more efficient manufacturing, and a reduction in greenhouse gas production. Since concrete is less expensive than steel, it may also be more cost effective to manufacture a portion of the foundation out of concrete compared to steel. The foundation may also open up regions to offshore wind that were previously not considered to be commercially viable.

The location of the foundation may be termed an offshore installation site.

The water at the offshore installation site may have a depth of 15 m to 40 m.

The foundation may protrude at least 20 m, or at least 25 m above the surface of the water. By extending this far above the waterline a wind turbine may be mounted directly onto the transition piece above the waterline, i.e. without the need for a transition element extending between the transition piece and the wind turbine. The foundation may protrude above the waterline by more than the hundred-year wave height at the installation site.

The pile may be tubular, i.e. a hollow elongate structure. Whilst the pile may have any cross sectional shape, it may be easier to install the transition piece on a cylindrical (i.e. having a circular cross section) pile due its high degree of rotational symmetry.

The pile may be formed of steel. Steel piles are commonly used as foundations for offshore wind turbines.

The transition piece may be mounted on the portion of the pile extending upward from the sea floor. For instance, the end of the pile may be received within the first end of the concrete support structure. In this way, a portion of the concrete support structure of the transition piece may surround and overlap with a portion of the pile. This may be termed an overlap region. The overlap region may include the entire portion of the pile that extends from the sea floor.

The first end of the transition piece may rest on the sea floor. For instance, when the transition piece includes a lip at the first end, the lip may rest on the sea floor. In this way, the transition piece can be at least partially supported by the sea floor.

The projections extending from the inner surface of the concrete support structure and/or the inflatable packers may rest on the distal end of the pile. This may provide additional support for the transition piece.

An annular gap may be formed between the outer surface of the pile and the inner surface of the concrete support structure. This annular gap may extend along the region of overlap between the concrete support structure and the pile. Grout, for instance concrete, may be provided within the annular gap to secure the transition piece to the pile. This may be termed a grout connection. The grout preferably extends around an entire circumference of the concrete support structure within the overlap region.

The annular gap may be fluidly sealed by the seal at the first end of the concrete support structure such that fluid, e.g. grout, may not pass out of the annular gap and into the surrounding sea water.

The foundation piece may be coupled to the pile by a slip joint. In this way, the transition piece may be permitted to move up and down relative to the pile a predetermined distance.

The skirt may penetrate, i.e. extend, into the sea floor. The skirt may help to prevent grout leaking from the annular gap between the outer surface of the pile and the inner surface of the concrete support structure. The skirt may extend into the sea floor to a depth within the range of 1 m to 5 m.

The outer diameter of the pile may be within the range of 5 m to 15 m, for instance 9 m to 11 m. Preferably, the portion of the pile that extends from the sea floor has an (maximum) outside diameter that is smaller than the inside diameter of the concrete support structure. This may allow the concrete support structure to fit over and around the pile, i.e. this may permit a portion of the pile extending up from the sea floor to be inserted into the tubular concrete support structure.

The inside diameter of the transition piece (e.g. the concrete support structure) and the (maximum) outside diameter of the pile (e.g. in the region extending from the sea floor) may differ by less than 150 mm. For instance, the diameters may differ by 120 mm or less, or 100 mm or less. In this way, a close fit can be achieved between the pile and the transition piece. It will be appreciated that the size of the annular gap between in inner surface of the concrete support structure and the outer surface of the pile will be effected by the relative diameters of these components. Hence, the width of the annular gap may be 75 mm or less, 60 mm or less, or 50 mm or less.

The diameter of the pile may be constant along its length, or may vary along its length. For instance, the pile may have a tapered, or chamfered, portion (i.e. a frustoconical portion) at its distal end. That is to say, the diameter of the pile may decrease towards the distal end of the pile. The tapered portion may have a length of 5 m. The tapered portion may allow for easier installation of the transition piece onto the pile, by making it easier to position the transition piece around the distal end of the pile during installation. The toe end of the pile may be tapered to assist during insertion of the pile into the sea floor.

The present invention may also extend to a fixed-foundation offshore wind turbine comprising the foundation of the second aspect. Hence, in a third aspect, the invention may provide a fixed-foundation offshore wind turbine comprising a wind turbine mounted on the foundation of the second aspect.

The fixed-foundation offshore wind turbine of the third aspect may include any one or more or all of the optional features discussed above in respect of the first and second aspects.

The wind turbine may be mounted to the transition piece.

The wind turbine may be mounted to the second end of the concrete support structure.

The wind turbine may include a tower. The tower may be mounted, preferably removably mounted, on the foundation.

The wind turbine may comprise a nacelle. The nacelle may be mounted, e.g. removably, on the tower, preferably at the top of the tower. The nacelle may be rotatably mounted to the tower. A generator and its associated electronics may be mounted, e.g. removably mounted, in or on the nacelle.

One or more rotor blades may be mounted, e.g. removably mounted, via a rotor hub to the nacelle. Preferably, the generator is configured to be driven by rotation of the rotor hub. The wind turbine may include, for example, three rotor blades. The rotor blades may be rotatably mounted to the rotor hub, for example such that their pitch may be controlled. The rotor hub and rotor blades together may form a rotor of the wind turbine.

The nacelle, the generator (and associated electronics and gearbox), and the rotor may together form a rotor-nacelle assembly.

The wind turbine may have a rotor diameter of greater than 100 m, more preferably greater than 150 m, and most preferably greater than 200 m. For instance, the wind turbine may have a rotor diameter of between 220 m and 250 m. Hence, the rotor blades may each have a length greater than 50 m, greater than 75 m, or greater than 100 m.

The rotor hub is preferably suitably located to accommodate the rotor.

Hence, to accommodate the rotor hub at a suitable height, the tower height may be greater than 100 m, greater than 150 m, or greater than 200 m.

The wind turbine may have a rated power output of greater than 3 MW, preferably greater than 10 MW. The wind turbine may have a rated power output of up to 15 MW.

In yet another aspect, the present invention may provide a method of installing a foundation for an offshore wind turbine. The method may comprise: providing a pile partially embedded in the sea floor such that an end of the pile extends from the sea floor, the end of the pile being below the waterline; and mounting a transition piece in accordance with the first aspect on the pile by lowering the transition piece towards the sea floor and onto the pile such that the end of the pile is received within the first end of the transition piece.

The transition piece may comprise any one or more or all of the optional features described above in respect of the first aspect.

The method may provide a foundation comprising any one or more or all of the optional features described above in respect of the first and second aspects.

The pile is received within the first end of the transition piece such that the first end of the transition piece peripherally engages with the end of the pile. That is to say, the first end of the transition piece is lowered onto the end of the pile and is fitted over and around the end of the pile.

Since the end of the pile is below submerged below the surface of the water, it will be appreciated that at least a portion transition piece (e.g. the first end) must be submerged in order for the end of the pile to be received by the first end of the transition piece.

Lowering the transition piece towards the end of the pile may include adding ballast to the ballast tanks of the transition piece. For instance, water, e.g. sea water, may be added to the ballast tanks. This may increase the mass of the transition piece sufficiently so that it sinks towards the sea floor.

The transition portion may be lowered onto the end of the pile such that the first end of the transition piece contacts the sea floor. The lip at the first end of the transition piece, if present, may contact the sea floor.

Lowering the transition piece onto the end of the pile may cause the skirt, or a portion thereof, to become embedded within the sea floor. Hence, the method may comprise embedding the skirt in the sea floor. The mass of the transition piece (and any ballast held in the ballast tanks) may be sufficient to drive the skirt into the sea floor. Thus, it may not be necessary to drive the skirt into the sea floor, e.g. by using a pile driver or similar, which may cause damage to the transition piece. The skirt may be embedded up to a depth of 5 m into the sea floor.

As the transition portion is lowered onto the pile, the projections on the inner surface of the concrete support structure (and/or the inflatable packers on the underside of the projections) may come to rest on the end of the pile. The extent of the overlap region may be adjusted by adjusting the position of the projections along the length of the concrete support structure and/or by adjusting the extent of inflation of the inflatable packers (e.g. by inflating and/or deflating the inflatable packers). The transition piece may be moved closer to the vertical relative to the pile by adjusting the position of the projections along the length of the concrete support structure and/or by adjusting the extent of inflation of the inflatable packers.

Before lowering the transition piece towards the end of the pile, the transition piece may be lifted and upended, so that it stands vertically, or substantially vertically. A heavy lift vessel (e.g. a crane vessel) may be used to lift the transition piece. The transition piece may then be lowered vertically towards the sea floor.

A heavy lift vessel may be used to guide the transition piece as it is lowered towards the end of the pile.

Once the first end has been lowered onto the pile and/or the first end of the transition piece has contacted the sea floor, the second end of the transition piece preferably protrudes above the waterline. The second end may protrude at least 20 m, or at least 25 m above the waterline.

Lowering the transition piece onto the pile may form an annular gap between the outer surface of the pile and the inner surface of the concrete support structure. This annular gap may be grouted in order to secure the transition piece to the pile. Grout may be passed to the annular gap via the conduits extending along the length of the concrete support structure towards the first end. Hence, the grout may be passed to the annular gap at the first end of the concrete support structure from the second end via the conduits.

The decks interior to the first end of the transition piece, the external platform and/or the ladder may be installed after the transition piece has been mounted on the pile. These components may be lifted, e.g. by a heavy lift vessel, and lowered into a mating relationship with the transition piece. For instance, the decks may be lowered into place within the transition piece. The decks, external platform and/or ladder may then be fixed in place in the known manner.

Alternatively, the decks, external platform and/or the ladder may be installed on the transition piece prior to installation of the transition piece on the pile. For instance, they may be installed on the transition piece onshore before the transition piece is transported to the installation site.

The method may include installing the pile on the sea floor prior to installing the transition piece on the pile. This may include lowering the toe end of the pile to the sea floor and driving the toe end into the sea floor. The pile may be driven into the sea floor by any suitable means, for instance using a pile driver.

Prior to installation, the pile may be lifted into an upright, e.g. vertical, orientation before being lowered towards the sea floor. A heavy lift vessel may be used to lift the pile into an upright orientation.

Lowering the pile towards the sea floor may include adding ballast to one or more ballast tanks within the pile. For instance, sea water may be added to the ballast tank(s). The addition of ballast may cause the pile to sink towards the sea floor.

The method may also include transporting the pile and/or the transition piece to the installation site.

The pile and the transition piece may each be manufactured at a different location. The pile may be manufactured at a pile manufacturing site (e.g. at a specialist foundry) and the transition piece may be manufactured at a transition piece manufacturing site. Preferably, the transition piece manufacturing site is closer to the installation site than the pile manufacturing site. That is to say, the travel distance between the pile manufacturing facility and the installation site may be greater than the travel distance between the transition piece manufacturing facility and the installation site. Accordingly, the distance travelled by the transition piece between the transition piece manufacturing site and the installation site may be less than the distance travelled by the pile between the pile manufacturing site and the installation site.

The transition piece manufacturing site may be located no more than 500 km from the installation site. Preferably, the transition piece manufacturing site is less than 100 km, more preferably less than 50 km from the installation site. Hence, the transition piece may be manufactured locally to the installation site.

The pile manufacturing facility may be located further from the installation site than the transition piece manufacturing site. For instance, the pile manufacturing site may be situated more than 50 km, or more than 100 km further from the installation site compared to the transition piece manufacturing site. Therefore, the pile manufacturing site may be located at least 100 km from the installation site. Preferably, the pile manufacturing site is located more than 150 km or more than 500 km from the installation site. In some case, the plie manufacturing site may be located more than 1000 km from the installation site, for instance more than 4000 km, or more than 6000 km from the installation site.

The pile may be transported directly from the pile manufacturing facility to the installation site, i.e. the pile may not be stored elsewhere before being transported to the installation site. This is not intended to preclude the storage of the pile at the pile manufacturing facility prior to the pile being transported to the installation site.

The pile may be lifted onto a pile transportation vessel, e.g. by a crane, at the pile manufacturing facility. The pile may be stored in a horizontal orientation, i.e. lying down, on the pile transportation vessel.

Since the pile is shorter and may have lower mass than piles that are conventionally used for foundations of fixed-foundation offshore wind turbines, the pile transportation vessel may be able to carry a larger number of the piles compared to conventional piles. The pile transportation vessel may be capable of carrying up to 10 piles at a time. Hence, up to 10 piles may be transported by the pile transportation vessel at a time.

The pile may be transported to the installation site by the pile transportation vessel.

Once the pile has arrived at the installation site, the pile may be lifted from the pile transportation vessel, e.g. by a heavy lift vessel, and lowered into position on the sea floor, as described above. Hence, the pile transportation vessel may be utilised during installation of the pile and/or foundation. That is to say, the vessel that is used during installation of the pile may be the same vessel that is used to transport the pile to the installation site. Hence, there may be no need to transfer the pile from the pile transportation vessel to a different, perhaps specialised, installation vessel prior to installation of the pile on the sea floor. This may save time and costs during the installation process.

The transition piece may be transported directly from the transition piece manufacturing facility to the installation site, i.e. the transition piece may not be stored elsewhere before being transported to the installation site. This is not intended to preclude the storage of the transition piece at the transition piece manufacturing facility prior to the pile being transported to the installation site.

The transition piece may be transported to the installation site on a transition piece transportation vessel, or may be floated to the installation site. For example, the transition piece may be lifted into the water at the transition piece manufacturing facility and towed to the installation site.

The transition piece may be lifted onto the transition piece transportation vessel, e.g. by a crane, at the transition piece manufacturing facility. The transition piece may be held in a horizontal orientation, i.e. lying down, on the transition piece transportation vessel. This may allow the transition piece to pass under obstacles, such as bridges, when being transported from the transition piece manufacturing facility towards the installation site.

The transition piece manufacturing facility may be located on the coast, for instance at a harbour, or may be situated inland. For instance, the transition piece manufacturing facility may be located on a river, up-river from the coast. Hence, the transition piece may be transported along a river or along rivers for at least some of the journey between the transition piece manufacturing facility to the installation site.

The transition piece transportation vessel may comprise a barge. The barge may be towed by a towing vessel.

The transition piece may be transported to the installation site by the transition piece transportation vessel.

Once the transition piece has arrived at the installation site, the transition piece may be lifted from the transition piece transportation vessel, e.g. by a heavy lift vessel, and lowered into position on the pile, as described above. Hence, the transition piece transportation vessel may be utilised during installation of the transition piece and/or foundation. That is to say, the vessel that is used during installation of the transition piece may be the same vessel that is used to transport the transition piece to the installation site. Hence, there may be no need to transfer the transition piece from the transition piece transportation vessel to a different, perhaps specialised, installation vessel prior to installation of the transition piece on the pile. This may save time and costs during the installation process.

The method may extend to installing a wind turbine on the foundation. The wind turbine may be mounted to the second end of the transition piece. Components and/or partially assembled pieces of the wind turbine may be mounted on the transition piece separately, i.e. one at a time. Components and/or partially assembled pieces of the wind turbine may be mounted on, or attached to, components and/or partially assembled pieces already installed on the transition piece. For instance, the tower may be installed on the transition piece and the nacelle subsequently mounted on the tower.

Alternatively, the wind turbine may be installed on the transition piece in one piece. That is to say that all of the major parts or components of the wind turbine, including at least the tower, nacelle, rotor hub and blades, may be assembled prior to being installed.

A heavy lift vessel may be used to lift the wind turbine, components of the wind turbine, and/or partially assembled pieces of the wind turbine into a mating relationship with the transition piece so as to facilitate installation on the foundation. For instance, the heavy lift vessel may be used to lift the wind turbine, components of the wind turbine, and/or partially assembled pieces of the wind turbine from a vessel and into a mating relationship with the transition piece.

At least part of the wind turbine may be mounted on the transition piece prior to the transition piece being installed on the pile. This may be done at an onshore location, e.g. the transition piece manufacturing facility, before the transition piece is transported to the installation site. For example, the tower may be mounted on the transition piece before the transition piece is installed on the pile at the installation site. Other wind turbine components and/or partially assembled pieces may be mounted on and/or attached to components already installed on the foundation at the installation site after the transition piece has been mounted on the pile. Alternatively, the wind turbine may be mounted on the foundation after the transition piece has been mounted on the pile.

The method may also comprise manufacturing the transition piece. The transition piece may be manufactured at the transition piece manufacturing facility. Manufacturing the transition piece may comprise casting the concrete support structure as a monolithic structure. This may be achieved using a slip-forming method, such as a vertical slip-forming method.

Forming the concrete support structure may alternatively comprise forming separate concrete parts and coupling them together to provide the concrete support structure. The separate concrete parts may comprise rings, i.e. tubular sections, or half pipe sections. The separate concrete parts may be formed by casting.

Half-pipe sections may be formed horizontally, i.e. lying down, in a half-pipe shaped mould comprising a cavity that defines the shape of a half-pipe section. Concrete may be poured into the mould and allowed to set in order to form the half-pipe section.

Once a first half-pipe section has been formed, a second half-pipe section may be formed in place on the first half-pipe section to complete the concrete support structure. This may include providing a mould along the longitudinal edges of the first half-pipe section. The mould may form an extension of the first half-pipe section and define a half-pipe shaped cavity. The cavity and the first half-pipe section may together form a tubular shape, e.g. having a circular cross section. Concrete may be poured into the mould and allowed to set in order to complete the tubular concrete support structure.

The skirt may be coupled to the second end of the concrete support structure. This may include inserting the connection rods of the skirt into the second end of the concrete support structure.

The connection rods of the skirt may penetrate into the cavity of the mould(s) so that the concrete may be poured around the connection rods. In this way, when the concrete sets, the connection rods may be encased within the concrete, coupling the skirt to the half-pipe section(s).

The method may further comprise coating the concrete support structure in epoxy. For instance, the inside and/or outside surface of the concrete support structure may be coated with epoxy. Epoxy may only be applied to joint regions of the concrete support structure, where separate concrete parts are joined together.

Certain embodiments of the present invention will now be described, by way of example only, and with reference to the accompanying drawings, in which:

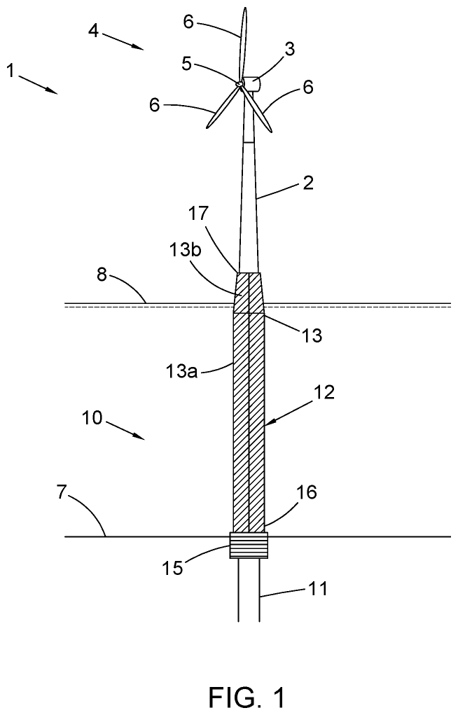

FIG. 1 shows a fixed-foundation offshore wind turbine;

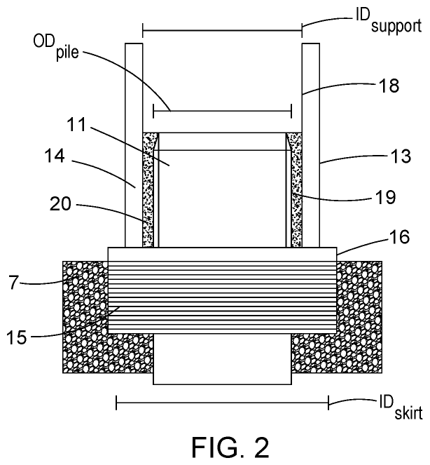

FIG. 2 shows a connection between a pile embedded in the sea floor and a transition piece for supporting an offshore wind turbine;

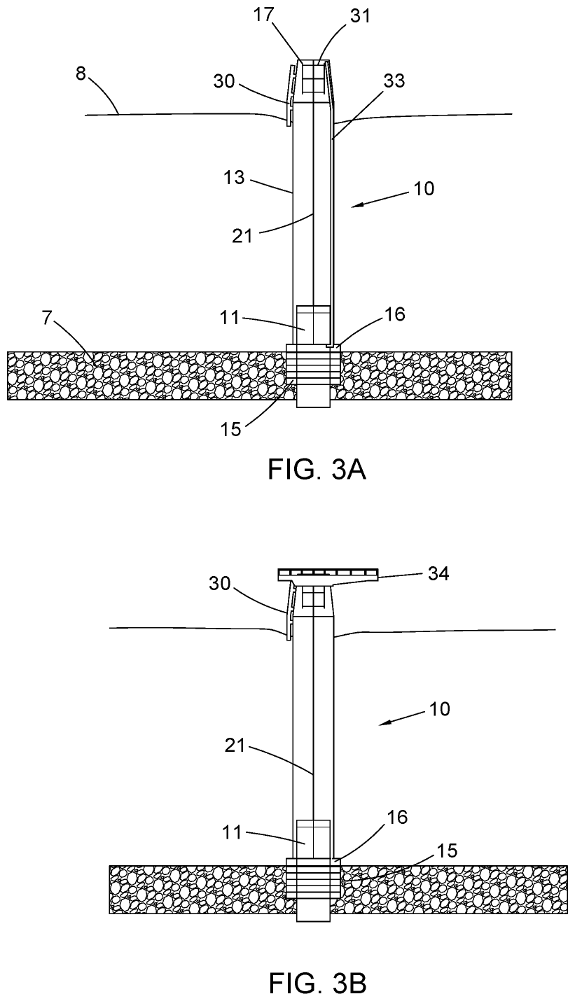

FIGS. 3A and 3B show foundations for supporting an offshore wind turbine;

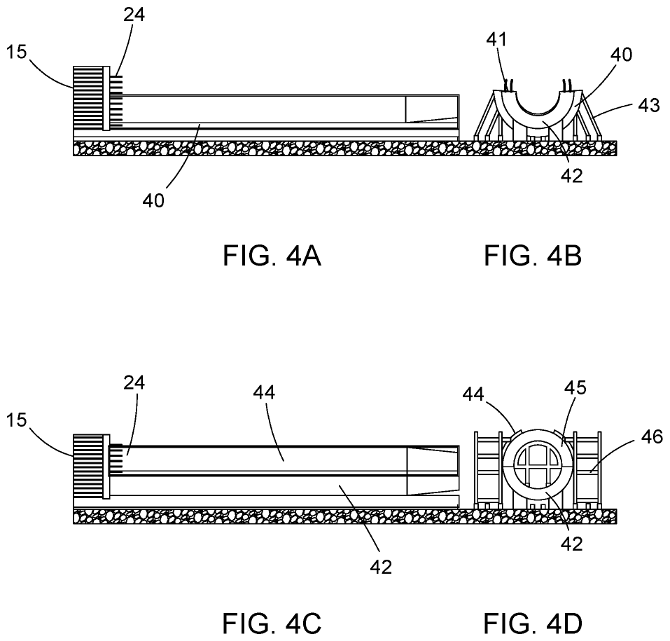

FIG. 4A shows an elevation view of a mould used for forming a transition piece of an offshore wind turbine foundation;

FIG. 4B shows a cross-section through the mould of FIG. 4A;

FIG. 4C shows an elevation view of a second mould used for forming a transition piece of an offshore wind turbine foundation; and

FIG. 4D shows a cross-section through the mould of FIG. 4B.

FIG. 1 illustrates a fixed-foundation offshore wind turbine 1. The wind turbine 1 comprises a tower 2, a nacelle 3 mounted at the top of the tower 2, and a rotor 4, comprising a rotor hub 5 and a plurality of blades 6, rotatably mounded to the nacelle 3.

The nacelle 3 may be configured to rotate about a longitudinal axis of the tower 2, which is approximately vertical in operation, and is controlled in operation to face into oncoming wind.

The rotor 4 is configured to rotate about a substantially horizontal axis so that the blades 6 are driven to rotate by the oncoming wind. The rotor 4 is coupled to a drive shaft of a generator (not shown) housed within the nacelle 3.

Offshore wind turbines are usually designed with large rotor diameters to generate a high output power to maximise cost efficiency. The wind turbine 1 may be designed to achieve a rated power output of around 10-15 MW and have a rotor diameter of between 220 m and 250 m.

The tower 2 is mounted on top of a foundation 10. The foundation 10 is fixed to the sea floor 14 and extends above the surface of the water 8 for supporting the tower 2 and other wind turbine components above the surface of the water 8. The foundation 10 includes a pile 11 and a transition piece 12 mounted to the pile 11.

The pile 11 comprises a hollow, tubular steel structure that is driven into the sea floor 7 a predetermined depth in order to support the wind turbine 1 against loads, e.g. caused by wave motion, wind, etc., acting on the wind turbine 1. For instance, the pile 11 may extend up to around 40 m to 50 m into the sea floor 7. An upper portion of the pile 11 protrudes from the sea floor 7 and upwards into the water. As can be seen from FIGS. 3A and 3B, the pile 11 does not project above the surface of the water 5 but extends only partially towards the surface of the water 5 from the sea floor 7. That is to say, the end of the pile 11 projecting from the sea floor 7 is completely submerged. For instance, where the depth of the water is 15 m to 40 m, the pile may extend only 5 m to 10 m upwards from the sea floor 7. The pile 11 may therefore be considerably shorter than piles that are conventionally used in foundations for offshore wind turbines, which often protrude above the surface 8 for the tower 2 to be mounted thereto. For instance, the pile may have length of no more than about 60 m.

As can be seen more clearly in FIG. 2, an upper end of the pile may be tapered or chamfered to assist in positioning the transition piece 12 on the pile 11.

The transition piece 12 is mounted on the upper portion of the pile 11 extending from the sea floor 7. As shown in FIG. 1, an upper end of the transition piece 12 projects above the surface of the water 8 and the tower 2 is mounted thereto.

The transition piece 12 comprises a concrete support structure 13 and a skirt 15. The concrete support structure 13 is an elongate tubular structure having a first end 16 that is configured to receive the end portion of the pile 11. As can more clearly be seen in FIGS. 2, 3A and 3B, the first end 16 of the concrete support 13 is fitted over the end of the pile 11 projecting from the sea floor 7 such that the end of the pile 11 is received within the first end 16. This may be termed a peripheral engagement. When the transition piece 10 is mounted on the pile 11, the first end 16 of the concrete support structure 13 may rest on the sea floor. The tower 2 is mounted to a second end 17 of the concrete support 13 that projects above the surface of the water 8.

In FIG. 1, the concrete support structure 13 has a lower cylindrical portion 13a and an upper cone portion 13b. The lower cylindrical portion 13a has a substantially constant diameter along its length. The cone portion 13b is a frustoconical portion that has a diameter at one end (i.e. the lower end) that is equal to the diameter of the cylindrical portion 13a and a diameter at the other end (i.e. the upper end, in this case the second end 17) that is smaller than the diameter of the lower portion 13a. Whilst the presence of the cone portion 13b is not essential, it may assist when mounting the tower 2 to the transition piece 12. For instance, the cone portion 13b may help to mitigate grout failure in a grout connection between the transition piece 12 and the tower 2.

The length of the concrete support structure 13 will depend on the depth of the water at the installation site of the offshore wind turbine 1, but it should be sufficient to extend from the sea floor 7 to above the surface of the water 8. For instance, the concrete support structure 13 may have a length of up to 65 m which will enable the foundation 10 to be used in water depths of up to around 40 m to 45 m. The concrete support structure 13 may extend more than 20 m above the surface of the water.

The skirt 15 is attached to the first end of the concrete support structure 13 and penetrates into the sea floor 7. The skirt 15 is a tubular structure that peripherally surrounds a portion of the pile 11 a predetermined distance under the sea floor. The skirt may 15 be formed from corrugated steel plate in order to resist buckling when the skirt 15 is forced into the sea floor 7.

The skirt may include connection rods 24 (shown in FIG. 4A) that extend into the first end 16 of the concrete support structure in order to couple the skirt 15 to the concrete support structure 13.

By extending into the sea floor 7, the skirt helps to support the transition piece 12, e.g. during installation of the transition piece 12 on the pile 11, by transferring axial and torsional loads to the sea floor 7. The skirt 15 also helps to protect the foundation 10 from scouring. The ability of the skirt 15 to support the transition piece 11 may depend on the type and consistency of the soil on the sea floor 7 at the installation site. For instance, a skirt penetrating into the soil a certain distance may be able to provide increased levels of support where the soil is hard compared to where the soil is relatively soft. Accordingly, the length of the skirt, and therefore the depth to which it penetrates the sea floor 7, may be chosen depending on the type of soil on the sea floor 7 at the installation site. The skirt may have a length of up to 5 m, but may be shorter, for example up to 3 m, when the soil on the sea floor 7 is hard.

In addition to the skirt 15, or as an alternative, the transition piece 12 may include a lip or flange (not shown) at the first end 16 of the concrete support structure 13. The lip may extend radially outwardly from the concrete support structure 13 at the first end 16 in order to increase the contact area between the concrete support structure 13 and the sea floor 7 when the transition piece 12 is installed on the pile 11. The lip may help to support the transition piece, for example against toppling over.

The connection between the pile 11 and the transition piece 12 will now be described with reference to FIG. 2. As discussed above, the transition piece is positioned on and around the pile 11 such that the portion of the pile 11 that projects from the sea floor 7 is received the within the concrete support structure 13 and the first end 16 of the support structure 13 rests on the sea floor 7. Hence, the portion of the pile 11 protruding from the sea floor 7 overlaps with a portion of the concrete support structure 13. The length of this overlapping region will depend on how far the pile 11 extends from the sea floor 7, but may be up to around 10 m.

It will be appreciated that an inside diameter of the concrete support structure IDₛᵤₚₚₒᵣₜ must be large enough so that the pile 11 may be received by the within the support structure 13. However, the difference between the inside diameter of the support structure IDₛᵤₚₚₒᵣₜ and an outside diameter of the pile ODₚᵢₗₑ should be selected to allow for a limited amount of adjustment to accommodate slight errors in the alignment of the pile.

That is, a degree of tolerance is provided between the inner surface 18 of the support structure 13 and the outer surface 19 of the pile 11 to allow the orientation of the support structure 13 to be adjusted relative to the pile 11. By providing a tolerance between the inner surface 18 of the support structure 13 and the outer surface 19 of the pile 11, the support structure 13 may be oriented closer towards the vertical relative to the pile 11. A tolerance may be provided such that the axial direction of the support structure 13 may be moved by up to around 1.25° from the axial direction of the pile 11.

In one example, the outside diameter of the pile ODₚᵢₗₑ is around 10 m and the inside diameter of the support structure IDₛᵤₚₚₒᵣₜ is around 300 mm larger than the outside diameter of the pile ODₚᵢₗₑ. Thus, an annular gap 20 of up to around 150 mm in thickness is formed between the outer surface 19 of the pile 11 and the inside surface 18 of the support structure 13. The annular gap 20 extends over the region of overlap between the pile 11 and the concrete support 13. As shown in FIG. 2, the annular gap 20 is filled with grout, e.g. concrete, to form a grouted connection to secure the transition piece 12 to the pile 11.

A seal (not shown) may be provided on the inner surface 18 of the concrete support 13 at the first end 16 in order to seal against the outer surface 19 of the pile 11 and prevent grout from leaking out of the annular gap 20 and into the surrounding sea water.

An inside diameter of the skirt IDₛₖᵢᵣₜ is also larger than the outside diameter of the pile ODₚᵢₗₑ so that the skirt 15 may be fitted over the pile 11. The region of overlap between the pile 11 and the concrete support structure 13 provides a majority of the support for the transition piece. Hence, it is not as important for the skirt 15 to follow the shape of the pile closely. The inside diameter of the skirt IDₛₖᵢᵣₜ may therefore be larger than the inside diameter of the support structure IDₛᵤₚₚₒᵣₜ.

Since the skirt 15 extends from the first end 16 of the concrete support structure 13 and penetrates the sea floor 7, the skirt 15 may also prevent grout from leaking out of the annular gap 20 and into the surrounding sea water.

As described above, the concrete support structure 13 is an elongate tubular structure. It is hollow and is formed by a curved concrete wall 14 defining a circular cross-section. The wall 14 may be formed of reinforced concrete and/or prestressed concrete, for example having steel rebars or the like embedded within the concrete. This may improve the tensile strength of the wall 14. The wall 14 may be about 150 mm thick.

The concrete support structures 13 shown in FIGS. 3A and 3B are each formed of two separate concrete parts that have been joined together along their lengths, for instance using concrete. The two concrete parts may be in the form of curved wall sections that each define a semicircle in cross-section, i.e. a half pipe. The joint between the two separate concrete parts is indicated in FIGS. 3A and 3B using the reference 21. The concrete support 13 may be formed in other ways, for instance from a plurality of rings that have been joined end-to-end.

Alternatively, the support structure 13 may be formed as a monolithic structure, i.e. it may be formed as a single piece of concrete. This may be achieved using a slip-forming manufacturing technique. It will be appreciated that in such a monolithic structure, there will be no joint(s) between separate parts.

An outer surface 22 of the concrete support structure 13 and/or the inner surface 18 of the concrete support structure 13 may be coated in an epoxy resin (not shown). This may help to waterproof the concrete support structure 13, in particular the joint(s) 21 between the separate concrete parts forming the support structure 13. The epoxy coating may be applied only on portions of the inner and/or outer surfaces 18, 22, for example only in the vicinity of the joint(s) 21, or may be applied on the entirety of the inner and/or outer surfaces 18, 22.

FIGS. 3A and 3B both show a foundation 10 installed on the sea floor 7. Each foundation 10 is provided with a different transition piece 12.

The transition piece 12 in FIG. 3A has a ladder 30 provided at the second end 17 of the concrete support 13. The ladder 30 extends from or below the surface of the water 8 and upwards towards the extreme end of the concrete support structure. This allows access to the upper end 17 of the transition piece 12, for example, for maintenance of the wind turbine 1. The transition piece 12 also includes internal decks 31 to provide platforms within the concrete support structure 13.

FIG. 3A shows a conduit 33 running lengthways through the wall 14 of the support structure 13 for directing grout, such as cement, from the second end 17 of the support structure 13 towards the annular gap 20 formed between the pile 11 and the concrete support structure 13. The conduit 33 is formed by a cavity within the wall 14, with an opening being provided in the inner surface 18 of the support structure 13 to fluidly connect the conduit 33 with the interior of the support structure 13. In another arrangement, the conduit 33 may be provided by a pipe running along the inner surface 18 of the support structure from the second end 17 towards the first end 16. Whilst only one conduit 33 is shown in FIG. 3A, a plurality of conduits 33 may be provided circumferentially spaced around the wall 14 of the support structure 13. Each conduit 33 may have a diameter of around 50 mm to 80 mm.

FIG. 3B shows an external platform 34 mounted at the second end 17 of the concrete support structure 13. This may be used, for example, during maintenance and servicing of the wind turbine 1. The ladder 30 may extend up to the platform 34 to allow access to the platform 34, for example from a vessel moored adjacent to the foundation 10.

The transition piece 12 may include one or more or all of the components shown in FIGS. 3A and 3B.

Unlike conventional steel pile foundations, the foundation 10 includes a transition piece 12 that is mounted to the pile 11 and extends from the sea floor 7 and projects above the surface of the water 8. Concrete can often be more easily and economically sourced compared to steel, and can be used more cheaply and simply to manufacture structures. Moreover, since concrete is easier than steel to work with, there is less of a need for such a highly skilled workforce to manufacture the concrete support structure 13. Hence, it may be possible to manufacture the transition piece 12, or at least the concrete support structure 13, at locations where it is not possible or economically viable to manufacture a steel pile. These locations may be closer to the intended installation site of the foundation 10 than the specialist pile manufacturing facilities. Accordingly, the distances travelled by a portion of the foundation 10 from its manufacturing site to the installation site can be reduced, making the transport of this portion to the installation site more efficient and less susceptible to sea conditions.

In an exemplary method of installing the foundation 10, the pile 11 may be manufactured at a pile manufacturing facility, for example in Europe. Up to 10 piles may be loaded onto a transportation vessel directly from the manufacturing site and then transported to the intended installation site of the foundation 10. The piles 11 may be laid horizontally on the transportation vessel. The installation site may be, for example, off the East coast of the USA. As such, the piles 11 may be transported up to around 8000 km from their manufacturing site to the installation site.

Once at the installation site, the pile 11 must be driven into the sea floor 7 to provide the foundation onto which the transition piece 12 is mounted. In a preferred method, the pile 11 is lifted from the transportation vessel at the installation site, for instance by a heavy lift vessel or a floating crane, and lowered towards the sea floor 7. This may be achieved by adding ballast, such as sea water, to the ballast tanks of the pile 11. The pile 11 may be held in a vertical configuration, for instance by a support structure that is mounted on the sea floor 7 at the installation site.

A pile driver may then be used to drive the pile 11 into the sea floor 7 a predetermined distance.

Since the transition piece 12 includes a concrete section, it can be manufactured at a different location to the pile 11. The facility where the transition piece is manufactured, which is different to the pile manufacturing facility, may be for example in the USA. For instance, the transition piece 12 may be manufactured in Coeymans, New York, USA. Accordingly, the distance between the manufacturing site of the transition piece 12 and the installation site may be not more than around 1000 km.

At the manufacturing site, a transition piece 12 comprising the concrete support structure 13 may be formed. Where desired, the transition piece may also include the skirt 15 and/or the lip. It is also envisaged that the transition piece may be fitted with the ladder 30, decks 31 and/or external platform 34 at the installation site. However, these may alternatively be secured to the concrete support structure 13 at the offshore installation site after the transition piece 12 has been installed on the pile 11.

Once manufactured, the transition piece 12 is lifted onto a barge, for example using a crane. The transition piece is lain in a horizontal orientation on the barge, and fastened to the barge in a known manner. Up to 2 transition pieces 12 may be loaded onto and held on the barge for transportation. The barge may then be then towed to the installation site.

At the installation site, the transition piece 12 is lifted from the barge, for example using a heavy lift vessel or a floating crane, and lowered towards the sea floor 7. This may be achieved by adding ballast, such as sea water to the ballast tanks of the transition piece 12.

The transition piece 12 may be held in a vertical orientation as it is lowered towards the sea floor 7 so that the first end 16 of the concrete support 13 may engage with the end of the pile 11 protruding from the sea floor 7. The crane and/or heavy lift vessel may be used to guide the first end 16 of the concrete support 13 towards the end of the pile 11 so that it may receive the end of the pile 11.

Once the end of the pile 11 is received within the first end 16 of the concrete support, the transition piece 12 may be further lowered until the first end 16 contacts the sea floor 7. As a result, the skirt 15, where present, will be driven into the sea floor 7. The weight of the transition piece (and any ballast contained therein) may be sufficient to drive the skirt 15 into the sea floor 7. That is to say, it may not be necessary to apply an external force to the transition piece, for instance from a pile driver, in order to cause the skirt 15 to penetrate the sea floor 7.

Lowering the transition piece 12 onto the pile 11 forms the annular gap 20 between the inner surface 18 of the concrete support 13 and the outer surface 19 of the pile. After the transition piece 12 is in position on the pile, grout is directed to the annular gap 20 and allowed to set in order to secure the transition piece to the pile. This may be achieved by pouring grout through the conduit(s) 33.

If not already provided prior to installation, for example during manufacture at the manufacturing site, the ladder 30, decks 31 and/or external platform 34 may mounted on the transition piece 12 after the transition piece 12 has been installed on the pile 11. A barge may be used to transport the ladder 30, decks 31 and/or external platform 34 to the installation site. At the installation site, the ladder, 30, decks 31 and/or external platform 34 may be lifted, for example using a heavy lift vessel or floating crane, into a mating relationship with the transition piece 12 and coupled to the transition piece 12 in the known manner.

Once the foundation 10 has been installed the wind turbine can be installed. The wind turbine may be transported to the installation site, for instance, on a barge. The floating wind turbine may be a fully assembled wind turbine, i.e. with most or all of the major wind turbine components (the tower 2, nacelle 3 and/or rotor components) assembled together. At the installation site, the wind turbine may be lifted by a crane or heavy lift vessel into a mating relationship with the transition piece 12 and then coupled to the transition piece 12 in the known manner. Alternatively, the wind turbine may be transported to the installation site in multiple pieces, and assembled on the foundation 10.

A method for manufacturing the transition piece 12, which may be carried out at the transition piece manufacturing facility, will now be described with reference to FIGS. 4A-4D.

FIG. 4A shows a first mould 40 for forming a half-pipe section of the concrete support structure 13. FIG. 4B shows the first mould 40 in cross section. As can be seen the first mould 40 defines a cavity 41 having a half-pipe shaped cross section. The mould 40 is arranged horizontally such that the half-pipe section, and the transition piece 12, may be formed in a horizontal orientation.

The connection rods 24 of the skirt 15 penetrate an end of the mould 40 so that they extend into the cavity 41.

Concrete may be poured into the mould 40 to form a concrete half-pipe section 42. The concrete flows around the connection rods 24. Hence, when the concrete sets, the connection rods 24 are encased in the concrete, thereby securing the skirt to the half-pipe section 42.

Once the concrete has set, the mould 40 may be removed. For instance, the mould 40 may be arranged on a sliding frame 43 such that it can be slid lengthways away from the half-pipe section 42.

A second mould 44 is arranged on the half-pipe section 42, as shown in FIGS. 4C and 4D. The second mould 44 extends over the edges of the half-pipe section 42 defines a half-pipe cavity 45. Together, the half-pipe section 42 and the cavity 45 define a tubular shape having a circular cross-section. The connection rods 24 of the skirt 15 also penetrate an end of the mould 44 so that they extend into the cavity 45.

Concrete is then poured into the mould 44, flowing into the cavity 45 and around the connection rods 24. The concrete will mate with the edges of the half-pipe section 42, thereby forming a complete tubular structure when set.

Once the concrete is set, the mould 44 is removed to expose the concrete support structure 13. The mould 44 may also be arranged on a sliding frame 46, such that it may be slid lengthways away from the set concrete structure. The connection rods 24 are encased in the concrete and thereby secured to the concrete structure.

An epoxy coating may then be applied to the concrete support structure. The ladder 30 and/or decks 31 may also be fixed to the concrete support structure 13 when it is in the horizontal orientation.

Once formed, the transition piece 12 may then be transported to the installation site and installed on the pile 11 as described above.

I claim:

1. A transition piece for use in a foundation of an offshore wind turbine, the transition piece comprising a tubular concrete support structure for supporting a wind turbine, the concrete support structure having a first end arranged to receive an end portion of a pile for mounting the transition piece on the pile, and a second end distal from the first end for supporting a wind turbine.

2. A transition piece according to claim 1, wherein concrete support structure has a length of at least 20 m.

3. A transition piece according to claim 1, wherein the concrete support structure has an inside diameter of 5 m to 15 m; and/or wherein the wall of the tubular concrete support structure has a thickness of 100 mm to 200 mm.

4. (canceled)

5. A transition piece according to claim 1, wherein the concrete support structure is formed of reinforced concrete; and/or wherein the concrete support structure is at least partially coated in epoxy.

6. A transition piece according to claim 1, comprising a skirt coupled to the first end of the concrete support structure for inserting into the sea floor, wherein the skirt preferably has a length of 1 m to 5 m.

7. A transition piece according to claim 6, wherein the skirt is formed of corrugated steel.

8. (canceled)

9. A transition piece according to claim 1, comprising at least one conduit extending along the length of the concrete support structure for directing grout towards the first end of the concrete support structure, wherein the conduit is formed within the wall of the concrete support structure.

10. A transition piece according to claim 1, wherein the concrete support structure comprises a ballast tank for storing ballast.

11. A foundation for an offshore wind turbine, comprising:
the pile having a toe end embedded in the sea floor and a distal end extending upwardly from the sea floor, wherein the distal end of the pile is below the surface of the water; and
the transition piece of claim 1 mounted on the distal end of the pile, wherein the transition piece protrudes above the surface of the water.

12. A foundation according to claim 11, wherein the pile extends not more than 10 m from the sea floor.

13. A foundation according to claim 11, wherein the distal end of the pile is received within the first end of the concrete support structure such that a portion of the concrete support structure surrounds and overlaps with a portion of the pile.

14. A foundation according to claim 11, wherein an annular gap is formed between the outer surface of the pile and the inner surface of the concrete support structure, wherein grout is provided in the annular gap to secure the transition piece to the pile.

15. A foundation according to claim 11, wherein the skirt penetrates the sea floor, wherein the skirt extends into the sea floor up to a depth of 1 m to 5 m.

16. A fixed-foundation offshore wind turbine comprising a wind turbine mounted on the foundation of claim 11, wherein the wind turbine comprises:
a tower mounted on the foundation;
a nacelle mounted at the top of the tower;
one or more rotor blades rotatably mounted to the nacelle by a rotor hub; and
a generator arranged to be driven by rotation of the rotor hub.

17. A method installing a foundation for an offshore wind turbine, comprising:
providing the pile partially embedded in the sea floor such that an end of the pile extends from the sea floor, the end of the pile being below the waterline; and
mounting the transition piece of claim 1 on the pile by lowering the transition piece towards the sea floor and onto the pile such that the end of the pile is received within the first end of the transition piece.

18. A method according to claim 17, wherein lowering the transition piece onto the pile forms an annular gap between the outer surface of the pile and the inner surface of the concrete support structure.

19. A method according to claim 18, comprising passing grout to the annular gap in order to form a grouted connection between the pile and the transition piece: wherein the grout is passed from the second end of the concrete support structure to the annular gap through conduits extending along the length of the concrete support structure.

20. (canceled)

21. A method according to claim 17, comprising transporting the pile to an installation site from a pile manufacturing site where the pile has been produced, and transporting the transition piece to the installation site from a transition piece manufacturing site where the transition piece has been produced, wherein the transition piece manufacturing site and the pile manufacturing site are at different locations.

22. A method according to claim 21, wherein the transition piece manufacturing site is located closer to the installation site than the pile manufacturing site, and/or wherein the transition piece manufacturing site is no more than 500 km from the installation site; and/or wherein the pile manufacturing site is located over 1000 km from the installation site.

23. (canceled)

24. (canceled)

25. A method according to claim 21, wherein the transition piece is transported to the installation site in a horizontal orientation.

26. (canceled)

27. A method according to claim 17, comprising forming the concrete support structure as a monolithic structure by slip-forming.
